(19) United States
(12) Patent Application Publication
(10) Pub. No.: US 2008/0297050 A1
(43) Pub. Date: Dec. 4, 2008

(54) PLASMA DISPLAY PANEL

(75) Inventors: Chong-Gi Hong, Yongin-si (KR); Tae-Kyoung Kang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung. SDI Co., Ltd., Suwon-si (KR)

(21) Appl. No.: 12/045,204

(22) Filed: Mar. 10, 2008

(30) Foreign Application Priority Data
May 31, 2007 (KR) 10-2007-0053285

(51) Int. Cl. H01J 17/49

(52) U.S. Cl. 313/585

(57) ABSTRACT

A plasma display panel including: first and second substrates facing each other; a barrier rib defining a plurality of discharge cells, disposed between the first and second substrates; a plurality of address electrodes disposed on the first substrate, adjacent to the discharge cells; and a plurality of transparent electrodes disposed on the second substrate, facing the discharge cells; and bus electrode connecting the transparent electrodes. Each of the transparent electrodes defines an opening through which light is discharged from the discharge cells. The transparent electrodes can further include one or more protrusions that extend into the openings.

### CROSS-REFERENCE TO RELATED APPLICATIONS

This application claims the benefit of Korean Application No. 2007-53285, filed May 31, 2007, in the Korean Intellectual Property Office, the disclosure of which is incorporated herein by reference.

### BACKGROUND OF THE INVENTION

1. Field of the Invention

Aspects of the present invention relate to a plasma display panel (PDP). More particularly, aspects of the present invention relate to a PDP having display electrodes having a reduced surface area, which have aspects that enhance discharge diffusion.

2. Description of the Related Art

Generally, a PDP generates plasma using a gas discharge, excites phosphors using ultra-violet rays emitted from the plasma in a vacuum, and realizes an image using red, green, and blue visible light, generated when the excited phosphors are stabilized.

A PDP includes front and rear substrates and discharge cells formed between the front and rear substrates. A PDP displays an image using visible light emitted from the discharge cells, toward the front substrate.

In an alternating current type PDP, address electrodes are formed on the rear substrate and a dielectric layer covers the address electrodes. Barrier ribs are disposed on the dielectric layer, between the address electrodes. The barrier ribs are formed in a striped pattern. Red, green, and blue phosphor layers are formed on the barrier ribs.

In each cell, display electrodes are paired with sustain and scan electrodes, on the front substrate, facing the rear substrate. The display electrodes extend across the address electrodes. The display electrodes are covered by a dielectric layer and an MgO protective layer.

The discharge cells are correspond to interesting regions, at which the address electrodes on the rear substrate intersect the pairs of sustain and scan electrodes. Millions of the discharge cells are arranged in a matrix pattern, in the PDP.

The display electrodes include transparent electrodes that generate surface discharges in the discharge cells, and bus electrodes to apply a voltage to the transparent electrodes. For example, when the transparent electrodes are formed of segments extending across the discharge cells, the reactive consumption power increases, due to the size increase of the transparent electrodes.

As another example, when the transparent electrodes are line members formed along outer blocks and central portions of the discharge cells, the reactive consumption power is reduced, due to the size reduction of the transparent electrodes. However, since the line members are arranged discontinuously, the discharge diffusion between the line members is weakened, and thus, the discharge efficiency is reduced. The above information disclosed in this Background section is only for enhancement of understanding of the background of the invention, and therefore, it may contain information that does not form the prior art that is already known in this country to a person of ordinary skill in the art.

### SUMMARY OF THE INVENTION

Exemplary embodiments of the present invention provide a PDP that can reduce reactive power consumption, by reducing the size of transparent electrodes, and can improve discharge efficiency, by enhancing discharge diffusion from the transparent electrodes.

In an exemplary embodiment of the present invention, a plasma display panel includes: rear and front substrates that face each other; a barrier rib defining a plurality of discharge cells, disposed between the rear and front substrates; a plurality of address electrodes disposed on one of the rear or front substrates, and aligned in a first direction with the discharge cells; and a plurality of transparent electrodes extending on the other of the front or rear substrates, in a second direction that intersects the first direction. The transparent electrodes are paired at each of the discharge cells, and are spaced apart from each other in the first direction. The transparent electrodes are paired, with one electrode of each pair facing each end of the respective discharge cell. The plasma display panel includes bus electrodes connecting the transparent electrodes in the second direction. The transparent electrodes include: first and second line members that respectively extend from the bus electrode, which correspond to opposite ends of the discharge cells, and are spaced apart from each other in the first direction, toward a central portion of the discharge cell; a third line member connecting the first and second line members in the second direction, at the central portion of the discharge cell, and a protrusion extending from at least one of the bus electrode and the first, second, and third line members, toward the bus electrode and the first, second, and third line members.

According to some exemplary embodiments, the protrusions may extend from the bus electrode toward the third line member.

According to some exemplary embodiments, the transparent electrode may further include a fourth line member extending in the second direction, at one of end of the discharge cell. The bus electrodes may be formed on the fourth line members.

According to some exemplary embodiments, the protrusions may extend from the fourth line members, toward the third line members. Each of the protrusions is formed in a hemispherical shape protruding toward the discharge cell.

According to some exemplary embodiments, the protrusions may include first protrusions extending from the fourth line members toward the third line members and second protrusions extending from the fourth line members toward the third line members. The first protrusions may face the respective second protrusions.

According to some exemplary embodiments, the protrusions may further include third protrusions extending from the first line members toward the second line members and fourth protrusions extending from the second line members toward the first line members. The third protrusions may face the respective fourth protrusions.

According to some embodiments, each of the protrusions may be rectangular, semicircular, triangular, or T-shaped.

According to some exemplary embodiments, each of the protrusions may be triangular, and may point toward the discharge cell.

According to some exemplary embodiments, the barrier rib may include first barrier rib members extending in the first direction to define the opposite ends of the discharge cell, which are spaced apart from each other in the second direction, and second barrier rib members extending in the second direction between the first barrier members, to define opposite ends of the discharge cell, which are spaced apart from each other in the first direction.

According to some exemplary embodiments, the barrier rib may include first barrier rib members extending in the first direction, to define opposite ends of the discharge cell, which are spaced apart from each other in the second direction, second barrier rib members extending in the second direction to define the opposite ends of the discharge cell, which are spaced apart from each other in the first direction, third barrier rib members provided to make a width of the discharge cell at the central portion of the discharge cell greater than widths of the discharge cell at the opposite ends of the discharge cell. The third barrier rib members connect the first barrier rib members to the second barrier rib members, in a direction crossing the first and second directions.

In another exemplary embodiment of the present invention, a plasma display panel includes: first and second substrates facing each other; a barrier rib defining discharge cells, disposed between the first and second substrates; address electrodes disposed upon the first substrate adjacent to the discharge cells; transparent electrodes disposed on the second substrate, such that pairs of transparent electrode face opposing ends of one of the discharge cells; and bus electrodes disposed across the opposing ends of the discharge cells, to electrically connect the transparent electrodes. Each transparent electrode defines an opening, through which light generated in the discharge cells passes.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the exemplary embodiments, taken in conjunction with the accompanying drawings, of which:

FIG. 1 is a schematic exploded perspective view of a PDP, according to a first exemplary embodiment of the present invention;

FIG. 2 is a sectional view taken along line II-II;

FIG. 3 is a top plan view illustrating an arrangement of a barrier rib and electrodes;

FIG. 4 is a top plan view illustrating an arrangement of a barrier rib and electrodes of a PDP, according to a second exemplary embodiment of the present invention;

FIG. 5 is a top plan view illustrating an arrangement of a barrier rib and electrodes of a PDP, according to a third exemplary embodiment of the present invention;

FIG. 6 is a top plan view illustrating an arrangement of a barrier rib and electrodes of a PDP, according to a fourth exemplary embodiment of the present invention;

FIG. 7 is a top plan view illustrating an arrangement of a barrier rib and electrodes of a PDP, according to a fifth exemplary embodiment of the present invention;

FIG. 8 is a top plan view illustrating an arrangement of a barrier rib and electrodes of a PDP, according to a sixth exemplary embodiment of the present invention; and

FIG. 9 is a top plan view illustrating an arrangement of a barrier rib and electrodes of a PDP, according to a seventh exemplary embodiment of the present invention.

### DETAILED DESCRIPTION OF THE EMBODIMENTS

Reference will now be made in detail to the exemplary embodiments of the present invention, examples of which are illustrated in the accompanying drawings, wherein like reference numerals refer to the like elements throughout. The exemplary embodiments are described below, in order to explain the aspects of the present invention, by referring to the figures.

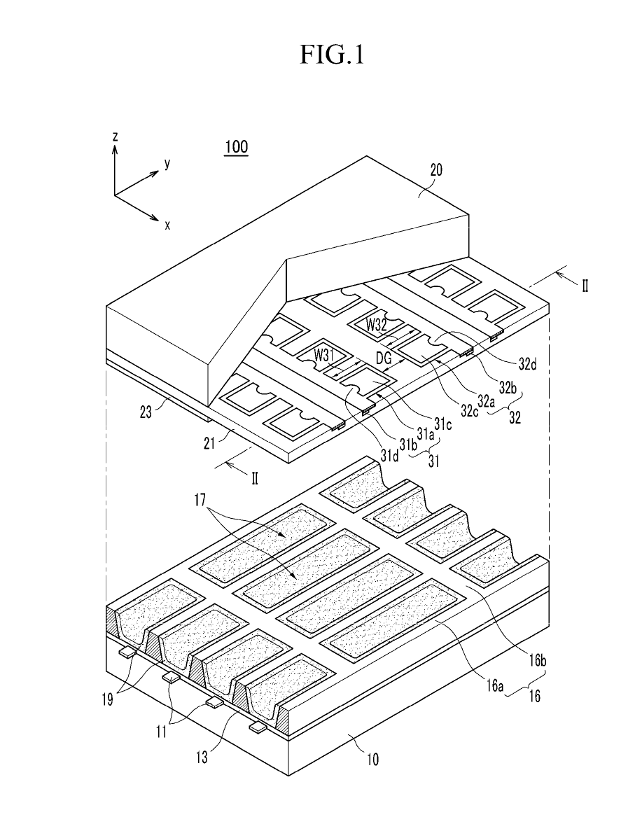

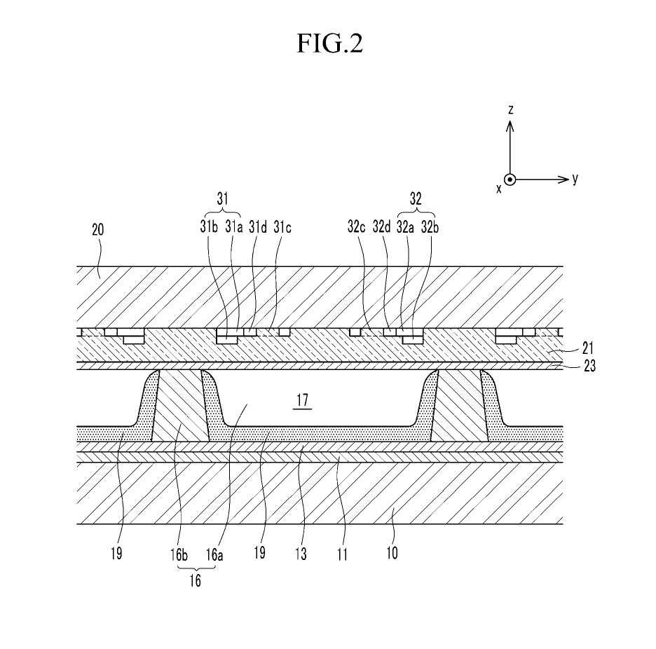

FIG. 1 is a schematic exploded perspective view of a PDP 100, according to a first exemplary embodiment of the present invention, and FIG. 2 is a sectional view taken along line II-II, of FIG. 1. Referring to FIGS. 1 and 2, the PDP 100 includes rear and front substrates 10 and 20 that face each other, and a barrier rib 16 disposed therebetween.

The barrier rib 16 has discharge cells 17 defined therein. The discharge cells 17 are filled with a discharge gas, for example, neon (Ne) and xenon (Xe). Phosphor layers 19 are disposed in the discharge cells 17. The discharge gas generates ultraviolet rays, through a gas discharge. The phosphor layers 19 are excited by the ultraviolet rays, and emit visible light when stabilized.

Address electrodes 11, first electrodes (sustain electrodes) 31, and second electrodes (scan electrodes) 32 are disposed between the rear and front substrates 10 and 20, adjacent to the discharge cells 17, to generate the gas discharge. For example, the address electrodes 11 are formed on an inner surface of the rear substrate 10. The address electrodes 11 extend in parallel, in a first direction (y-direction in FIG. 1), across the discharge cells 17. The discharge cells 17 have a long axis that extends in the y-direction. The address electrodes 11 are spaced apart from each other in a second direction (x-direction in FIG. 1).

The first dielectric layer 13 is formed on the inner surface of the rear substrate 10, and covers the address electrodes 11. The first dielectric layer 13 prevents the address electrodes 11 from being damaged, and accumulates wall charges. That is, the first dielectric layer 13 prevents cations, and/or electrons, from directly colliding with the address electrodes 11.

The address electrodes 11 may be formed of a non-transparent material. For example, the address electrodes 11 may be formed of silver (Ag), or other metals that have excellent electrical conductivity. Since the address electrodes 11 are disposed on the rear substrate 10, they do not interfere with the transmission of the visible light. For example, the barrier rib 16 is provided on the first dielectric layer 13, which is formed on the rear substrate 10. The barrier rib 16 includes first barrier rib members 16a and second barrier rib members 16b, which define the discharge cells 17. The discharge cells can form a matrix pattern.

The first barrier rib members 16a extend in the y-direction, and are spaced apart from each other in the x-direction. The second barrier rib members 16b extend in the x-direction, and are spaced apart from each other in the y-direction. The barrier rib may not include the second barrier rib members 16b, in some exemplary embodiments. That is, the barrier rib may be formed with only the first barrier rib members 16a. In this case, the first barrier rib members are disposed in parallel with each other, in the x-direction, to form the discharge cells 17 in a striped pattern (not shown).

The phosphor layers 19 are generally formed by depositing phosphor paste on sidewalls of the barrier rib 16, and on surfaces of the first dielectric layer 13 that are surrounded by the barrier rib 16. The phosphor paste is dried to form the phosphor layers 19.

The phosphor layers 19 extend in the y-direction, and are formed of phosphors that emit visible light. The phosphor layers 19 are formed of different phosphors, which emit different wavelengths of visible light (i.e., red, green, and blue light). That is, the phosphor layers 19 formed of the phosphors emitting the red, green, and blue visible light, and are alternately arranged in the x-direction.

The sustain electrodes 31 and the scan electrodes 32 are arranged on an inner surface of the front substrate 20, adjacent to the discharge cells 17. The sustain electrodes 31 and the scan electrodes 32 form a surface discharge structure, to generate gas discharges in each of the discharge cells 17.

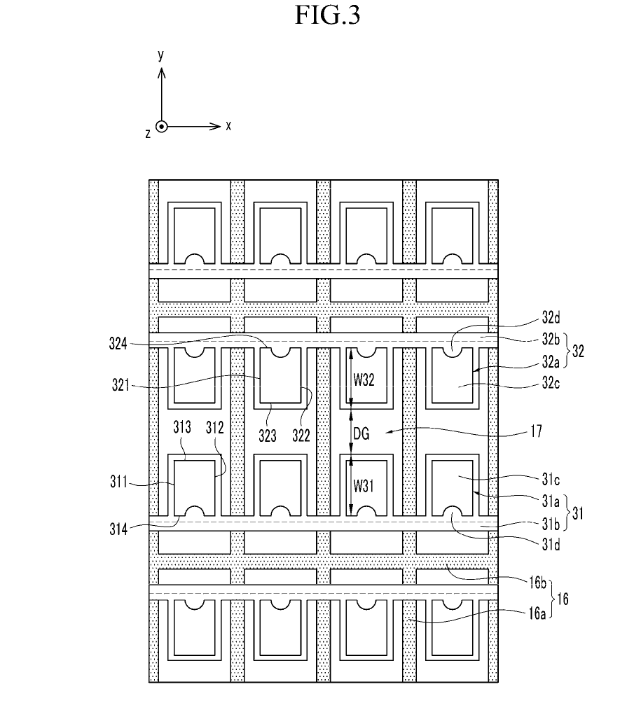

FIG. 3 is a top plan view illustrating an arrangement of the barrier rib 16 and the electrodes 31, 32. Referring to FIG. 3, the sustain electrodes 31 and the scan electrodes 32 extend in the x-direction, and intersect the address electrodes 11. Each of the sustain electrodes 31 includes a transparent electrode 31a to generate discharges, and a bus electrode 31b to apply a voltage signal to the transparent electrode 31a. Likewise, each of the scan electrodes 32 includes a transparent electrode 32a to generate discharges, and a bus electrode 32b to apply a voltage signal to the bus electrode 23a.

The transparent electrodes 31a and 32a are disposed in the discharge cells 17, and are formed of a transparent material, such as, indium tin oxide (ITO), to ensure sufficient aperture ratios of the discharge cells 17. The bus electrodes 31b and 32b are formed of metal having excellent electrical conductivity, to effectively apply the voltage signal to the transparent electrodes 31a and 32a.

The transparent electrodes 31a and 32a extend in the y-direction, over the discharge cells 17. The transparent electrodes 31a and 32a respectively have widths W31 and W32. A discharge gap DG is formed between corresponding pairs of the transparent electrodes 31a and 32a.

The bus electrodes 31b and 32b extend in the x-direction across ends of the discharge cells 14, and are connected to the transparent electrodes 31a and 32a. Accordingly, the voltage signals applied to the bus electrodes 31b and 32b are applied to the respective transparent electrodes 31a and 32a.

Referring again to FIGS. 1 and 2, a second dielectric layer 21 is formed on the inner surface of the front substrate 20, to cover the sustain and scan electrodes 31, 32. The second dielectric layer 21 protects the sustain and scan electrodes 31, 32 from the gas discharge, and accumulate wall charges during the discharge.

A protective layer 23 is formed to cover the second dielectric layer 21. For example, the protective layer 23 is formed of transparent MgO, to transmit visible light, and to protect the second dielectric layer 21. The protective layer 23 increases a secondary electron emission coefficient, during the discharge.

When the rear and front substrates 10 and 20 are adhered to each other, the barrier rib 16 on the rear substrate 10 contacts the protective layer 23 on the front substrate 20. A fine passage (not shown), defined between the barrier rib 16 and the protective layer 23, functions to allow air to be exhausted from of the discharge cells 17, and the discharge gas to be filled in the discharge cells 17.

In the PDP 100, discharge cells 17 are turned on, in accordance with address discharges generated by the address and scan electrodes 11, 32. The selected discharge cells 17 are driven, in accordance with sustain discharges generated by the sustain and scan electrodes 31 and 32, thereby displaying an image.

The transparent electrodes 31a, 32a will now be described in more detail, with reference to FIGS. 2 and 3. The transparent electrodes 31a, 32a define openings 31c, 32c that correspond to inner portions of the discharge cells 17. Since the openings 31c, 32c reduce the size of the transparent electrodes 31a, 32a, the reactive power consumption of the transparent electrodes 31a, 32a is reduced. The second dielectric layer 21 formed by dielectric material for covering the bus electrodes 31b, 32b and the transparent electrodes 31a, 32a. Therefore, the openings 31c, 32c is filled with the dielectric material.

The transparent electrodes 31a, 32a include protrusions 31d, 32d which extend toward central portions of the openings 31c, 32c. The protrusions 31d, 32d compensate for weakened discharge diffusion, due to the openings 31c, 32c. The protrusions 31d, 32d reduce a distance between opposite sides of the openings 31c, 32c, of each of the transparent electrodes 31a, 32a, to compensate for the weakened discharge diffusion.

The openings 31c, 32c minimize the blocking of visible light emitted toward the front substrate 20, thereby improving luminance efficiency. The protrusions 32d, 32d partly intercept the visible light passing through the openings 32c, 32c, to reduce unit light, thereby improving the expression of low grayscales. In more detail, the transparent electrodes 31a, 32a include first line members 311, 321, second line members 312, 322, and third line members 313, 323, which at least partially define the openings 31c, 32c.

The first line members 311, 321 extends in the y-direction, adjacent to first sides of the discharge cells 17, and are spaced part from each other in the x-direction. That is, the first line members 311, 321 extend from the bus electrodes 31b, 32b, toward a central portion of the discharge cell 17 (e.g., toward the discharge gap DG), in parallel with the first barrier members 16a.

The second line members 312, 322 extend in the y-direction at second sides of the discharge cell 17. That is, the second line members 312, 322 extend from the bus electrodes 31b, 32b, toward the center of the discharge cell 17 (e.g., toward the discharge gap DG), in parallel with the first barrier members 16a. The first line members 311, 321 and the second line members 312, 322 are arranged in parallel with each other, and in parallel with the first barrier members 16a, and are spaced apart from each other in the x-direction.

The third line members 313, 323 connect the first line members 311, 321 and the second line members 312, 322, in the x-direction, at central portions of the discharge cells 17. That is, the third line members 313, 323 extend in the x-direction, to connect the first line members 311, 321 and the second line members 312, 322.

In the sustain and scan electrodes 31, 32, the discharge gap DG is defined between the adjacent third line members 313, 323. As described above, each of the transparent electrodes 31a, 32a is formed by the first line members 311, 321, the second line members 313, 323, and the third line members 313, 323.

The bus electrodes 31b, 32b extend in the x-direction, at opposing ends of the discharge cells 17, to define ends of the opening 31c, 32c. The first line members 311, 321, the second line members 312, 323, and the bus electrodes 31a, 32a at least partially define the openings 31c, 32c.

One end of the openings 31c, 32c may be defined by the bus electrodes 31b, 32b. Alternatively, as shown in FIGS. 1 to 3, one end of the opening 32c, 32c may be defined by both the bus electrodes 31b, 32b and fourth line members 314, 324.

The fourth line members 314, 324 extend in the x-direction, at the opposite ends of the discharge cells 17, and are spaced apart from each other in the y-direction. When the fourth line members 314, 324 are provided, the bus electrodes 31b, 32b are formed on the fourth line members 314, 324 (see FIG. 2).

The protrusions 31d, 32d extend from at least one of the bus electrodes 31b, 32b, the first line members 311, 321, the second line members 312, 322, and the third line members 313, 323, toward the centers of the openings 31c, 32c. For example, the protrusions 31, 32d protrude from the bus electrodes 31b, 32b, toward the third line members 313, 323 (see FIG. 3). The protrusions 31d, 32d protrude in the y-direction.

The protrusions 31d, 32d reduce distances between the bus electrodes 31b, 32b and the third line members 313, 323, to compensate for the weakened discharge diffusion, resulting from the third line members 313, 323 defining the discharge gap DG toward the bus electrodes 31b, 32b. The protrusions 31d, 32d enhance the discharge diffusion, in the y-axis direction. When the fourth line members 314, 324 are provided, the protrusions 31d, 32d may be formed on the bus electrodes 31b, 32b, or on the fourth line members 314, 324.

The protrusions 31d and 32d reduce a distance between the fourth line members 314, 324 and the third line members 313, 323, to enhance the discharge diffusion from the third line members 313, 323 to the fourth line members 314, 324. For example, the protrusions 31d, 32d are semicircular shapes protruding from the fourth line members 314, 324, toward the centers of the discharge cells 17. The protrusions 31d, 32d enhance the discharge diffusion radially, into the discharge cells 17.

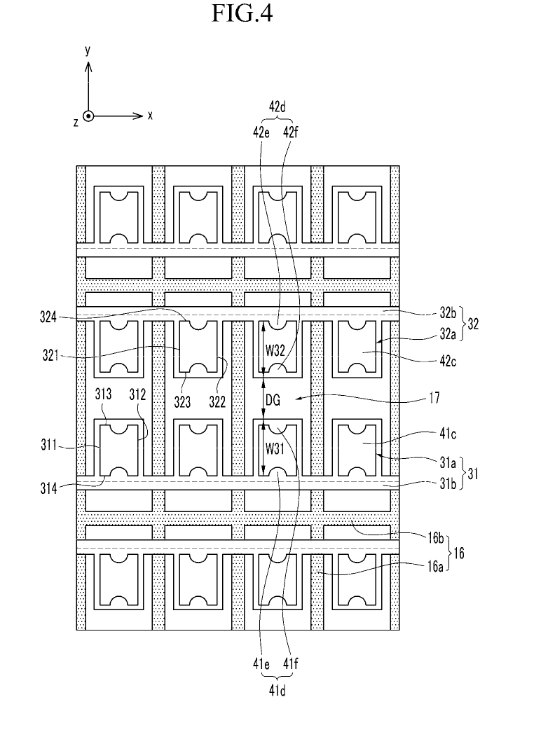

In the following exemplary embodiments, parts identical to those of the first embodiment will not be described, as only different parts will be described. FIG. 4 is a top plan view of an arrangement of a barrier rib and electrodes of a PDP, according to a second exemplary embodiment of the present invention.

Unlike the first exemplary embodiment, protrusions 41d, 42d of the second exemplary embodiment include first protrusions 41e, 42e and second protrusions 41f, 42f. The first protrusions 41e, 42e protrude from fourth line members 314, 324, toward third line members 313, 323. The second protrusions 41f, 42f protrude from the third line members 313, 323, toward the fourth line members 314, 324. The first protrusions 41e, 42e face the second protrusions 41f, 42f, in the y-direction.

The first protrusions 41e, 42e and the second protrusions 41f, 42f further reduce the lengths of openings 41c, 42c, in the y-direction. As compared with the openings 31c, 32c of first exemplary embodiment, the discharge diffusion can be further enhanced. The first protrusions 41e, 42e and the second protrusions 41f, 42f further reduce unit light deterioration, as compared with the first exemplary embodiment, where only the protrusions 31d, 32d extend into each of the openings 31c, 32c.

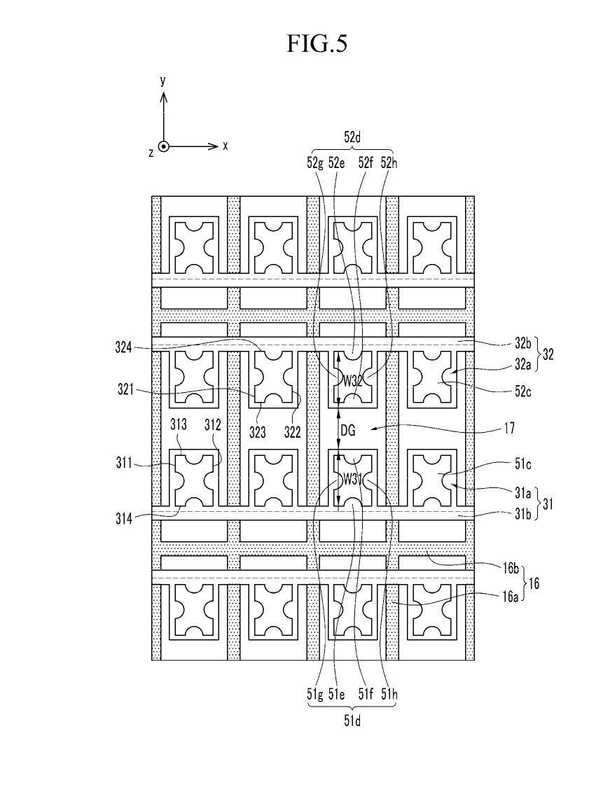

FIG. 5 is a top plan view illustrating an arrangement of a barrier rib and electrodes of a PDP, according to a third exemplary embodiment of the present invention. Unlike the second exemplary embodiment, the third exemplary embodiment further includes third protrusions 51g, 52g and fourth protrusions 51h, 52h, in addition to first protrusions 51e, 52e and second protrusions 51f, 52f.

The third protrusions 51g, 52g protrude from first lines member 311, 321, toward second line members 312, 322. The fourth protrusions 51h, 52h protrude from the second line members 312, 322, toward the first line members 311, 321. The third protrusions 51g, 52g and the fourth protrusions 51h, 52h face each other in the x-direction.

The third protrusions 51g, 52g and the fourth protrusions 51h, 52h reduce a length of openings 51c, 52c in the x-direction, to enhance the discharge diffusion in the x-direction. The third protrusions 51g, 52g and the second protrusions 51h, 52h further reduce unit light deterioration, as compared with the second exemplary embodiment, where the first protrusions 41e, 42e and the second protrusion 41f, 42f extend into the openings 41c, 42c.

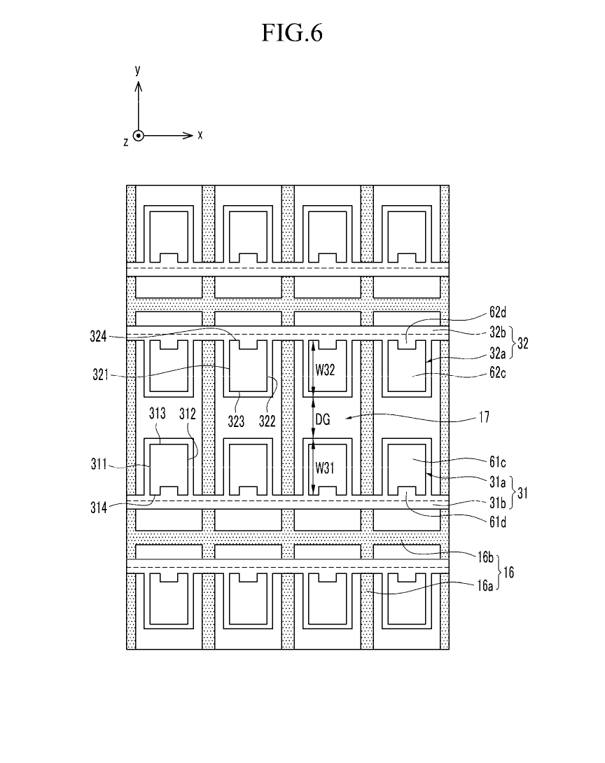

FIG. 6 is a top plan view illustrating an arrangement of a barrier rib and electrodes of a PDP, according to a fourth exemplary embodiment of the present invention. Unlike the first exemplary embodiment, protrusions 61d, 62d of this exemplary embodiment are formed in a rectangular shape.

The protrusions 61d, 62d enhance the discharge diffusion from the centers of the rectangular protrusions 61d, 62d, toward an overall region of the openings 61c, 62c. Angular points of the protrusions 61d, 62d enhance the discharge diffusion toward corners of the discharge cells 17.

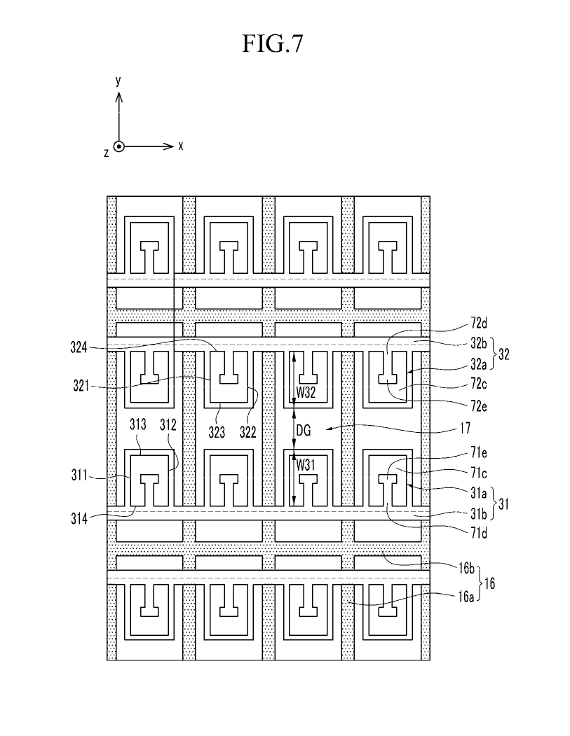

FIG. 7 is a top plan view illustrating an arrangement of a barrier rib and electrodes of a PDP, according to a fifth exemplary embodiment of the present invention. Unlike the fourth exemplary embodiment, protrusions 71d, 72d of this exemplary embodiment have enlarged portions 71e, 72e. In other words, the protrusions 71d, 72d are T-shaped. The protrusions 71d, 72d and the enlarge portions 71e, 72e further reduce the lengths of openings 71c, 72c in the y-direction, to enhance the discharge diffusion. The protrusions 71d, 72d and the enlarged portions 72e, 72e reduce unit light deterioration, as compared with the fourth exemplary embodiment, which includes only the protrusions 61d, 62d.

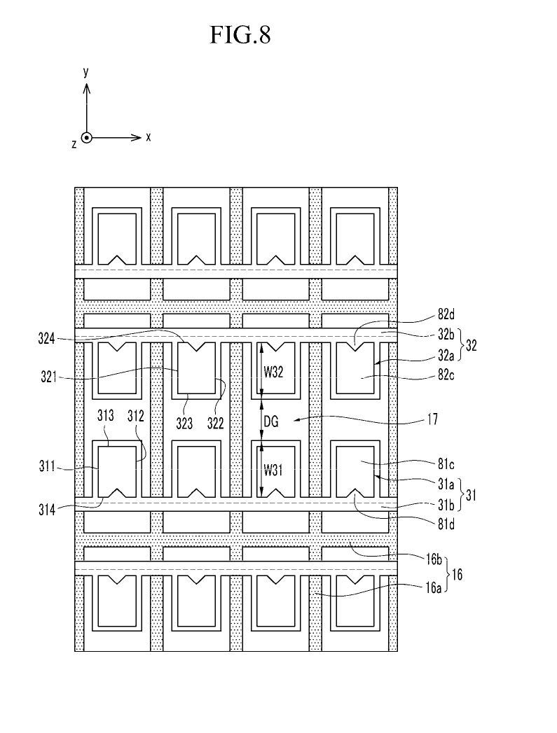

FIG. 8 is a top plan view illustrating an arrangement of a barrier rib and electrodes of a PDP, according to a sixth exemplary embodiment of the present invention. Unlike the first and fourth exemplary embodiments, protrusions 81d, 82d of this exemplary embodiment are triangular and point toward a center of openings 81c, 82c. In the first, fourth, and sixth embodiments, a variety of shapes of the protrusions, which have similar effect, are shown by way of example.

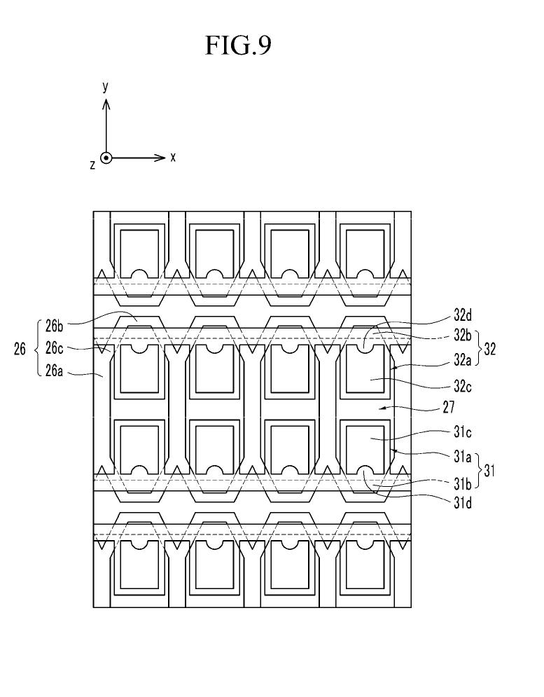

FIG. 9 is a top plan view illustrating an arrangement of a barrier rib and electrodes of a PDP, according to a seventh exemplary embodiment of the present invention. Unlike the first through sixth exemplary embodiments, a barrier rib 26 of this exemplary embodiment includes first barrier rib members 26a, second barrier rib members 26b, and third barrier rib members 26c. The transparent electrodes and protrusions of the first through sixth exemplary embodiments may be identically applied to this seventh exemplary embodiment. Therefore, a detailed description of these parts is omitted.

The first barrier rib members 26a extend in the y-direction, to define opposite sides of discharge cells 27, and are spaced apart from each other in the x-direction. The second barrier rib members 26b extend in the x-direction, to define opposite ends of the discharge cells 27, and are spaced apart from each other in the y-direction.

The third barrier rib members 26c are angled, such that the widths of the discharge cells 27 are greater at the centers of the discharge cells 27, than at the opposite ends of the discharge cells 27. That is, the third barrier rib members 26c connect the first barrier rib members 26a to the second barrier rib members 26b, in a direction crossing the X and y-directions.

The discharge diffusion may not be effectively realized at the opposite ends of the discharge cells 27, which have the relatively more narrow widths as compared at the central portion of the discharge cell 27. However, the protrusions 31d, 32d enhance the discharge diffusion at the opposite ends having the relatively narrow widths.

According to the exemplary embodiments of the present invention, by forming the openings on transparent electrodes, the surface area of each of the transparent electrodes can be reduced. Therefore, the reactive power consumption can be reduced. In addition, since protrusions extending toward the center of the openings are formed on the transparent electrodes, the discharge can be effectively diffused in the openings. Therefore, the discharge efficiency can be improved.

Since the protrusions extending toward the openings are formed at both ends of discharge cells, which have narrowed opposing ends, the discharge diffusion at the narrowed ends can be enhanced. Further, since the protrusions formed on the transparent electrodes partially block the visible light passing through the openings, unit light can be reduced. Therefore, the expression of low grayscales can be improved.

Although a few embodiments of the present invention have been shown and described, it would be appreciated by those skilled in the art that changes may be made in these embodiments, without departing from the principles and spirit of the invention, the scope of which is defined in the claims and their equivalents.

What is claimed is:

1. A plasma display panel comprising:
a first substrate;
a second substrate facing and spaced apart from the first substrate;
a barrier rib defining discharge cells, disposed between the first and second substrates;
address electrodes disposed on the first substrate adjacent to the discharge cells;
transparent electrodes disposed on the second substrate, such that pairs of transparent electrode are disposed to face each of the discharge cells, with each transparent electrode of the pairs facing a different opposing end of a respective one of the discharge cells; and
bus electrodes disposed across the opposing ends of the discharge cells, to electrically connect the transparent electrodes;
wherein each of the transparent electrodes defines an opening, and comprises a protrusion that extends into the opening.

2. The plasma display panel of claim 1, wherein each of the transparent electrodes comprises:
first and second line members that respectively extend from a respective one of the bus electrodes, which form first and second opposing sides of the opening, and
a third line member connecting the first and second line members, to form a third side of the opening that is spaced apart from the respective bus electrode.

3. The plasma display panel of claim 2, wherein each of the transparent electrodes further comprises a fourth line member connecting the first and second line members, which forms a fourth side of the opening, which faces the third line member.

4. The plasma display panel of claim 3, wherein the bus electrodes are formed on the fourth line members.

5. The plasma display panel of claim 4, wherein the protrusions extend from the fourth line members toward the third line members.

6. The plasma display panel of claim 5, wherein each of the protrusions is semicircular.

7. The plasma display panel of claim 1, further comprising a dielectric layer formed by dielectric material for covering the bus electrodes and the transparent electrodes, and the opening is filled with the dielectric material.

8. The plasma display panel of claim 3, wherein:
the protrusions extend from the fourth line members toward the third line members of each transparent electrode; and
the transparent electrodes further comprise second protrusions extending from the third line members toward the fourth line members.

9. The plasma display panel of claim 8, wherein the protrusions of each transparent electrode face one another.

10. The plasma display panel of claim 8, wherein the transparent electrodes further comprise:
third protrusions extending from the first line members toward the second line members; and
fourth protrusions extending from the second line members toward the first line members.

11. The plasma display panel of claim 10, wherein in each transparent electrode the third protrusion faces the fourth protrusion.

12. The plasma display panel of claim 1, wherein the protrusions are rectangular.

13. The plasma display panel of claim 1, wherein the protrusions are T-shaped.

14. The plasma display panel of claim 1, wherein the protrusions are triangular.

15. The plasma display panel of claim 1, wherein the discharge cells are rectangular.

16. The plasma display panel of claim 1, wherein the opposing ends of the discharge cells are more narrow than central portions of the discharge cells.

17. A plasma display panel comprising:
first and second substrates facing each other;
a barrier rib defining discharge cells, disposed between the first and second substrates;
address electrodes disposed upon the first substrate adjacent to the discharge cells;
transparent electrodes disposed on the second substrate, such that pairs of transparent electrode are disposed to face each of the discharge cells, with each transparent electrode of the pairs facing a different opposing end of a respective one of the discharge cells; and
bus electrodes disposed across the opposing ends of the discharge cells, to electrically connect the transparent electrodes,
wherein each transparent electrode defines an opening.

18. The plasma display panel of claim 17, wherein each of the transparent electrodes comprises a protrusion that extends into the opening.

19. The plasma display panel of claim 17, wherein each of the transparent electrodes comprises first and second protrusions extending toward each other, into the opening.

20. The plasma display panel of claim 18, wherein the protrusions are semicircular, triangular, rectangular, or T-shaped.

21. The plasma display panel of claim 17, wherein each of the transparent electrodes comprises two opposing pairs of protrusions that extend into the opening.

22. The plasma display panel of claim 17, wherein the transparent electrodes comprise sustain electrodes and scan electrodes.

23. The plasma display panel of claim 17, wherein the opposing ends of the discharge cells are more narrow than central portions of the discharge cells.

24. The plasma display panel of claim 17, further comprising a dielectric layer formed by dielectric material for covering the bus electrodes and the transparent electrodes, and the opening is filled with the dielectric material.
